(19) United States
(12) Patent Application Publication
(10) Pub. No.: US 2020/0147762 A1
(43) Pub. Date: May 14, 2020

(54) TWO-WAY RETRACTABLE SOCKET

(71) Applicant: PO-YEN CHANG, Taichung City (TW)

(72) Inventor: PO-YEN CHANG, Taichung City (TW)

(21) Appl. No.: 16/189,237

(22) Filed: Nov. 13, 2018

(51) Int. Cl. B25B 13/06; B25B 23/00

(52) U.S. Cl. CPC B25B 13/06; B25B 23/0035

(57) ABSTRACT

A two-way retractable socket is provided, including an outer sleeve, having two spline holes, each of the two spline holes having a plurality of ribs which are circumferentially arranged in intervals and a plurality of engaging grooves which are circumferentially alternatively arranged with the plurality of ribs, the plurality of engaging grooves configured for receiving driving heads of objects in different dimensions; two inner sleeves, each of the two inner sleeves including a hexagonal hole and a plurality of engaging teeth arranged around the hexagonal hole and configured to be slidably received within the plurality of engaging grooves; two elastic members, respectively received in the two spline holes and biasing the two inner sleeves outwardly.

### BACKGROUND OF THE INVENTION

### Field of the Invention

The present invention relates to a socket, and more particularly to a two-way retractable socket.

### Description of the Prior Art

A socket is one of the tools which is commonly used to assemble or disassemble devices. The socket is used to actuate a fixing member (for example, a screw, a bolt or a nut) to rotate so as to assemble components into one piece or disassemble the components. The socket is often used with a driving tool (for example, a wrench) to increase moment arm so as to produce a greater torsion to drive the fixing member to rotate; or the socket may be used with a pneumatic/electrical tool to save physical efforts.

However, the common sockets are designed for driving the fixing members in one dimension. Although most of the fixing members follow a uniform standard, but the fixing members have various dimensions and modes to correspond to components in different sizes. Therefore, to address the fixing members in different dimensions, a user needs to prepare different types of sockets which cause not only weight burden but also economic burden to the user, and it needs a larger space to save the sockets. In addition, it is inconvenient that the user needs to change the sockets frequently and repeatedly assemble and disassemble the sockets.

The present invention has arisen to mitigate and/or obviate the afore-described disadvantages.

### SUMMARY OF THE INVENTION

The major object of the present invention is to provide a two-way retractable socket which has sleeves in different dimensions.

To achieve the above and other objects, a two-way retractable socket is provided, including an outer sleeve, having two spline holes, each of the two spline holes having a plurality of ribs which are circumferentially arranged in intervals and a plurality of engaging grooves which are circumferentially alternatively arranged with the plurality of ribs, the plurality of engaging grooves configured for receiving driving heads of objects in different dimensions; two inner sleeves, each of the two inner sleeves including a hexagonal hole and a plurality of engaging teeth arranged around the hexagonal hole and configured to be slidably received within the plurality of engaging grooves; two elastic members, respectively received in the two spline holes and biasing the two inner sleeves outwardly.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferred embodiment of the present invention;

FIG. 2 is a breakdown view of the preferred embodiment of the present invention;

FIG. 3 is a cross-sectional view of the preferred embodiment of the present invention;

FIG. 4 is a side view and a partially-enlarged view of the preferred embodiment of the present invention; and

FIGS. 5 and 6 are drawings showing the preferred embodiment of the present invention in application.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

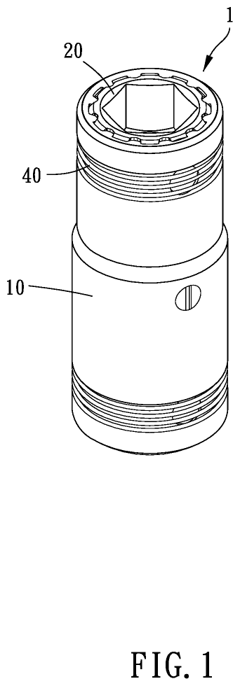

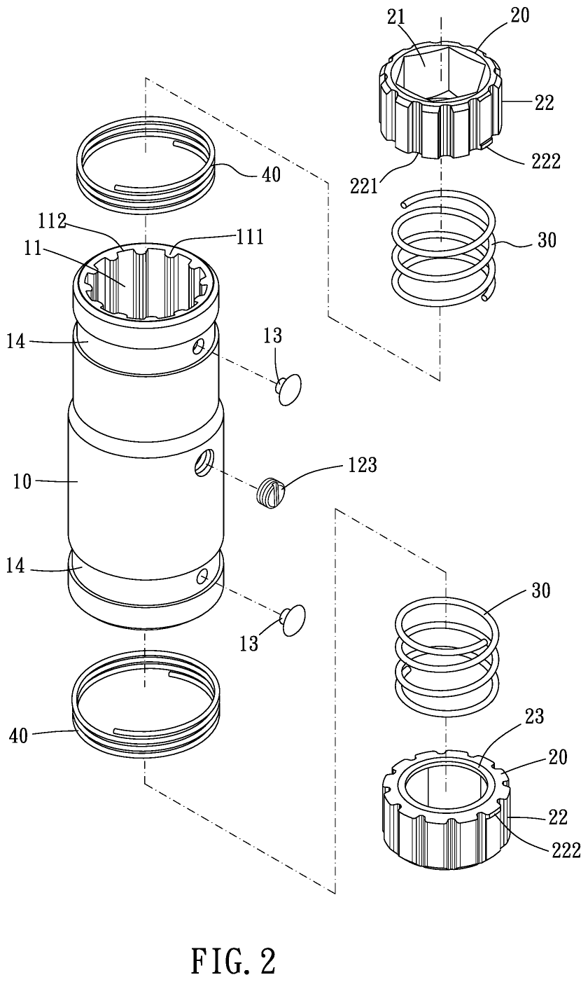

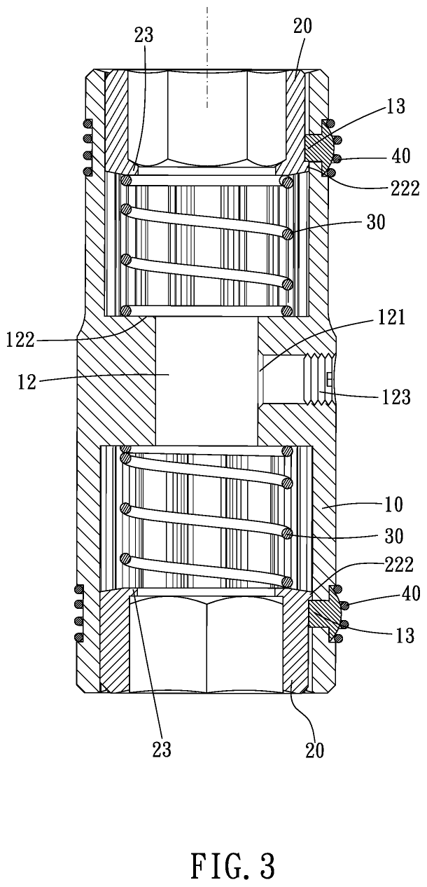

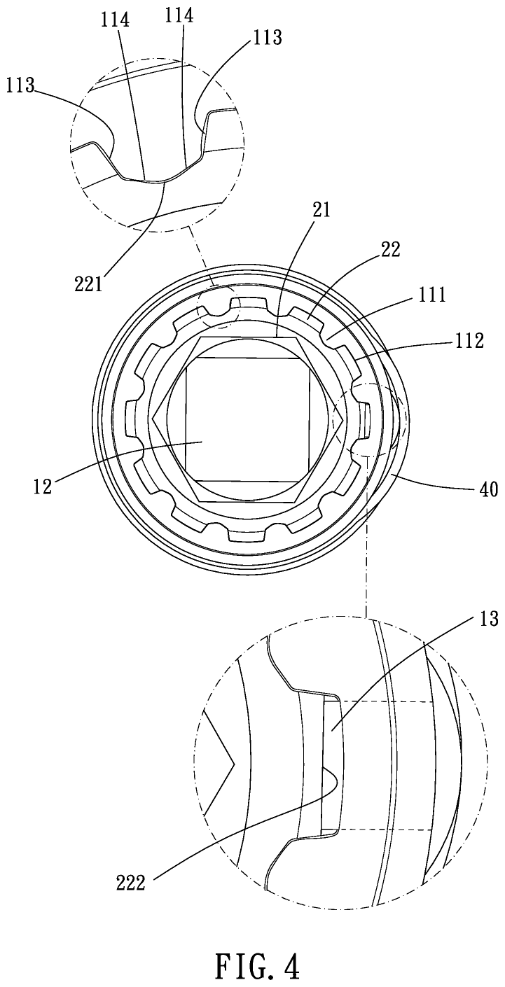

Please refer to FIGS. 1 to 4 for a preferred embodiment of the present invention. A two-way retractable socket 1 includes an outer sleeve 10, two inner sleeves 20 and two elastic members 30.

The outer sleeve 10 has two spline holes 11, each of the two spline holes 11 has a plurality of ribs 111 which are circumferentially arranged in intervals and a plurality of engaging grooves 112 which are circumferentially alternatively arranged with the plurality of ribs 111, and the plurality of engaging grooves 112 are configured for receiving driving heads of objects in different dimensions. Each of the two inner sleeves 20 includes a hexagonal hole 21 and a plurality of engaging teeth 22 arranged around the hexagonal hole 21 and configured to be slidably received within the plurality of engaging grooves 112. The two elastic members 30 are respectively received in the two spline holes 11 and bias the two inner sleeves 20 outwardly. Preferably, the two splines holes have different dimensions, and hexagonal holes 21 of the two inner sleeves 20 are in different dimensions. Therefore, both ends of the socket provide sleeves in different dimensions to be applied to objects in various dimensions, for example, fixing members like screws or bolts or other similar objects.

A number of the plurality of engaging grooves 112 is more than 6, in this embodiment, there are 12 engaging grooves 112 which can be divided into sets equi-angularly, the sets of the engaging grooves 112 defines sleeves in different dimensions which can be applied to objects in different dimensions and with different number of corners, and preferably, the two spline holes 11 has a set of the engaging grooves in different dimensions. The outer sleeve 10 further includes two square holes 12 which are disposed between the two spline holes 11, in this embodiment, the two square holes 12 communicates with each other, and at least one wall of at least one of the two square holes 12 further has at least one engaging recess 121. The square hole 12 is configured for a driving head of a driving tool (manual, pneumatic or electrical) to be assembled thereto, and the engaging recess 121 is for an elastic engaging structure of the driving head of the driving tool to be engaged therewith. Each of the two square holes 12 and one of the two of spline holes 11 defines a shoulder face 122 which faces one of the two of inner sleeves 20, and each of the two elastic members 30 biases one of the two shoulder faces 122. The engaging recess radially penetrates the outer sleeve 10 for a rod to be inserted therein to reverse. A plug 123 can be further plugged into the engaging recess 121 (a screw can be screwed thereinto) to prevent foreign objects from entering.

With the cooperation of the plurality of engaging grooves 112 and the plurality of ribs 111, the outer sleeve 10 can be stably assembled to the inner sleeve to effectively disperse stress and make the inner sleeve 20 actuate accurately. Preferably, a number of the plurality of ribs 111 and a number of the plurality of engaging grooves 112 are the same, but the number of the plurality of ribs 111 may be less than the number of the plurality of engaging grooves 112. On a radial cross section of the outer sleeve 10, each of the plurality of ribs 111 includes two lower slant sides 113 which are tapered toward a center of the outer sleeve 10 and two upper slant sides 114 which extend from the two lower slant sides 113 and connect with each other, each of the upper slant sides 114 is smaller than each of the lower slant sides 113 in gradient absolute value, the lower slant side 113 is for the object to be inserted to abut thereagainst stably, and the upper slant side 114 can prevent corners of the object to be inserted from being damaged. Every adjacent two of the plurality of engaging teeth 22 define a spline groove 221 therebetween, and on a radial cross section of each of the two inner sleeves 20, a contour of each spline groove 221 is complementary to a contour of one of the plurality of ribs 111, and a toothed contour of the upper and lower slant sides 113, 114 complementary to the spline grooves 221 can effectively increase the structure strength, prevent slippery and increase a contact area and torsion transmitted on a rotation direction.

The outer sleeve 10 further has at least one blocking protrusion 13 in each of the plurality of spline holes 11 (may be further arranged or integrally formed), each of the two inner sleeves 20 has at least one engaging protrusion 222 which is blockable by the at least one blocking protrusion 13 on an axial direction to prevent the inner sleeve 20 from detachment, and the blocking protrusion 13 may be a screw member screwed with the outer sleeve 10 but may also be a flange, a bead, a pin, a hook, a rivet or something similar. In this embodiment, the at least one blocking protrusion 13 is disposed through the outer sleeve 10 and restricted by a hoop 40 which surrounds the outer sleeve 10, and the hoop 40 may be, for example but not limited thereto, a ring spring, a rigid sheet or an elastic sheet. Preferably, the hoop 40 is annularly arranged within an annular groove 14 of the outer sleeve 10, the hoop 40 is stably positioned, and an exterior surface of the outer sleeve 10 is smooth.

Each of the two inner sleeves 20 further includes a radially-inward flange 23 which abuts against one of the two elastic members 30 to stably abut against the inner sleeve 20, and the radially-inward flange 23 can stably and precisely position the object to be inserted.

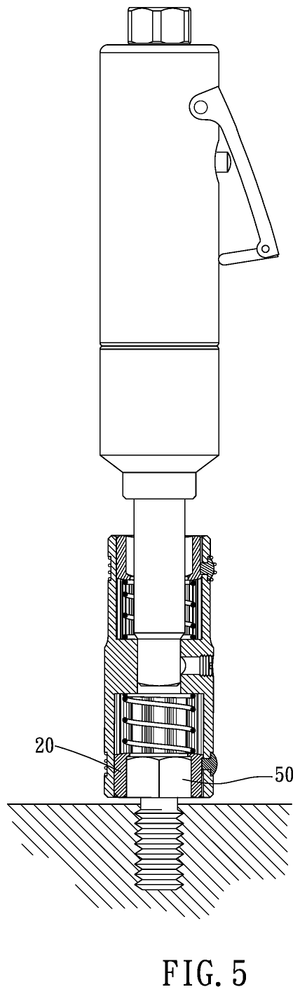

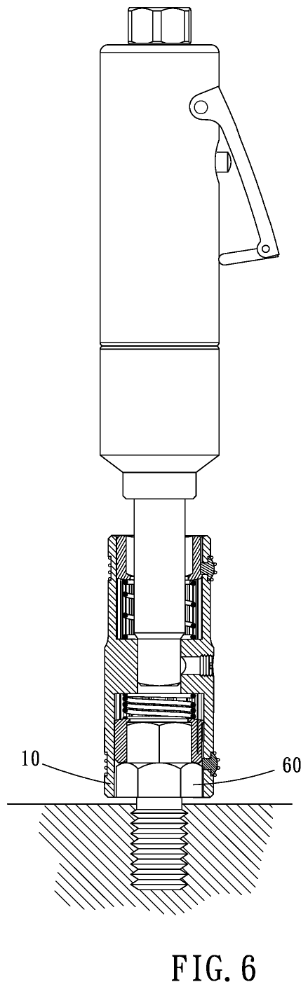

In actual practice, for example, the two-way retractable socket 1 may be sleeved to a hexagonal bolt 50 or a nut via the inner sleeve 20 (as shown in FIG. 5), when the hexagonal bolt 50 or the nut is greater than the hexagonal hole of the inner sleeve 20 in dimension, the user can press the hexagonal bolt 50 or the nut into the spline hole (as shown in FIG. 6) to drive the hexagonal bolt 50 or the nut via the outer sleeve 10.

While we have shown and described various embodiments in accordance with the present invention, it should be clear to those skilled in the art that further embodiments may be made without departing from the scope of the present invention.

What is claimed is:

1. A two-way retractable socket, including:
an outer sleeve, having two spline holes, each of the two spline holes having a plurality of ribs which are circumferentially arranged in intervals and a plurality of engaging grooves which are circumferentially alternatively arranged with the plurality of ribs, the plurality of engaging grooves configured for receiving driving heads of objects in different dimensions;
two inner sleeves, each of the two inner sleeves including a hexagonal hole and a plurality of engaging teeth arranged around the hexagonal hole and configured to be slidably received within the plurality of engaging grooves;
two elastic members, respectively received in the two spline holes and biasing the two inner sleeves outwardly.

2. The two-way retractable socket of claim 1, wherein a number of the plurality of engaging grooves is more than 6.

3. The two-way retractable socket of claim 1, wherein the outer sleeve further includes two square holes which are disposed between the two spline holes, each of the two square holes and one of the two of spline holes defines a shoulder face which faces one of the two of inner sleeves, and each of the two elastic members biases one of the two shoulder faces.

4. The two-way retractable socket of claim 3, wherein at least one wall of at least one of the two square holes further has at least one engaging recess.

5. The two-way retractable socket of claim 1, wherein on a radial cross section of the outer sleeve, each of the plurality of ribs includes two lower slant sides which are tapered toward a center of the outer sleeve and two upper slant sides which extend from the two lower slant sides and connect with each other, and each of the upper slant sides is smaller than each of the lower slant sides in gradient absolute value.

6. The two-way retractable socket of claim 5, wherein every adjacent two of the plurality of engaging teeth define a spline groove, and on a radial cross section of each of the two inner sleeves, and a contour of each spline groove is complementary to a contour of one of the plurality of ribs.

7. The two-way retractable socket of claim 1, wherein each of the two inner sleeves further includes a radially-inward flange which abuts against one of the two elastic members.

8. The two-way retractable socket of claim 1, wherein the outer sleeve further has at least one blocking protrusion in each of the plurality of spline holes, and each of the two inner sleeves has at least one engaging protrusion which is blockable by the at least one blocking protrusion on an axial direction.

9. The two-way retractable socket of claim 8, wherein the at least one blocking protrusion is disposed through the outer sleeve and restricted by a hoop which surrounds the outer sleeve.

10. The two-way retractable socket of claim 9, wherein the hoop is annularly arranged within an annular groove of the outer sleeve.
